(19) United States
(12) Patent Application Publication
(10) Pub. No.: US 2026/0106075 A1
(43) Pub. Date: Apr. 16, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Wonmi Choi, Suwon-si (KR); Byungkun Kim, Suwon-si (KR); Yuhong Oh, Suwon-si (KR); Dongjun Jung, Suwon-si (KR); Hyun Kim, Suwon-si (KR); Jiyoung Lee, Suwon-si (KR); Hongseok Kim, Suwon-si (KR)

(73) Assignee: SAMSUNG ELECTRO-MECHANICS CO., LTD., Suwon-si (KR)

(21) Appl. No.: 19/202,835

(22) Filed: May 8, 2025

(30) Foreign Application Priority Data
Oct. 16, 2024 (KR) 10-2024-0141366
Nov. 20, 2024 (KR) 10-2024-0166272

(51) Int. Cl. H01G 4/008; H01G 4/012; H01G 4/30

(52) U.S. Cl. CPC H01G 4/008; H01G 4/012; H01G 4/30

(57) ABSTRACT

A multilayer ceramic capacitor including a capacitor body including a plurality of dielectric layers and a plurality of internal electrode layers stacked with the dielectric layers interposed therebetween; and an external electrode disposed on an outer surface of the capacitor body, wherein the internal electrode layer includes an internal region and an interface region that is disposed on at least one surface of the internal region in a stacking direction and includes an interface with the dielectric layer, the internal region and the interface region include germanium (Ge), an average content of germanium (Ge) in the interface region is higher than an average content of germanium (Ge) in the internal region.

### CROSS-REFERENCE TO RELATED APPLICATION

This application claims priority to and the benefit of Korean Patent Application No. 10-2024-0166272 filed in the Korean Intellectual Property Office on Nov. 20, 2024, and Korean Patent Application No. 10-2024-0141366 filed in the Korean Intellectual Property Office on Oct. 16, 2024, the entire contents of which are incorporated herein by reference.

### BACKGROUND

### (a) Technical Field

The present disclosure relates to a multilayer ceramic capacitor and a manufacturing method thereof.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the development of electronic devices and autonomous vehicles, there is a growing demand for miniaturizing the multilayer ceramic capacitor and making its capacitance large. In order to achieve higher capacitance with the same volume, it is necessary to make a dielectric layer and an internal electrode layer thin. However, the thinning of the dielectric layer and the internal electrode layer may increase electric field intensity per unit area, which leads to deterioration in reliability.

### SUMMARY

An embodiment provides a multilayer ceramic capacitor having excellent reliability.

Another embodiment provides a method of manufacturing a multilayer ceramic capacitor.

An embodiment provides a multilayer ceramic capacitor including a capacitor body including a plurality of dielectric layers and a plurality of internal electrode layers stacked with one dielectric layer among the plurality of dielectric layers interposed between adjacent internal electrode layers among the plurality of internal electrode layers; and an external electrode disposed on an outer surface of the capacitor body, wherein at least one internal electrode layer among the plurality of internal electrode layers includes an internal region and an interface region that is disposed on at least one surface of the internal region in a stacking direction, the interface region includes an interface with an dielectric layer among the plurality of dielectric layers, the internal region and the interface region include germanium (Ge), and an average content of germanium (Ge) in the interface region is higher than an average content of germanium (Ge) in the internal region.

A ratio of the average content of germanium (Ge) in the interface region to the average content of germanium (Ge) in the internal region may be greater than about 1 and less than or equal to about 5.

The interface region may be a region having a depth of 2 nm from the interface with the adjacent dielectric layer into an interior of the at least one internal electrode layer.

In a transmission electron microscopy-energy dispersive spectroscopy (TEM-EDS) image, when analyzing a line in a straight section from one point of the at least one internal electrode layer to one point of the adjacent dielectric layer, the interface region may have a maximum mol % of germanium (Ge).

The interface region may further include germanium oxide (GeO₂).

The internal region and the interface region may further include nickel (Ni).

In a transmission electron microscopy-energy dispersive spectroscopy (TEM-EDS) image, when analyzing a line in a straight section from one point of the adjacent dielectric layer to one point of the at least one internal electrode layer, the internal region may have a maximum mol % of nickel (Ni).

In a transmission electron microscopy-energy dispersive spectroscopy (TEM-EDS) image, when analyzing a line in a straight section from one point of the adjacent dielectric layer to the at least one internal electrode layer, the interface region may be a region extending from a point having a concentration of nickel (Ni) that is ⅓ of a maximum mol % of nickel (Ni) to a distance of 2 nm into an interior of the at least one internal electrode layer.

The average content of germanium (Ge) in the interface region may be about 0.4 parts by mole to about 12 parts by mole based on 100 parts by mole of nickel (Ni) in the interface region.

The interface region may further include at least one selected from titanium (Ti) and barium (Ba).

The average content of germanium (Ge) in the internal region may be about 0.2 parts by mole to about 10 parts by mole based on 100 parts by mole of nickel (Ni) in the internal region.

The interface region may have a thickness of about 0.05% to about 3% of a total thickness of the at least one internal electrode layer.

The plurality of dielectric layers may include barium (Ba), titanium (Ti) and germanium (Ge).

An average thickness of the at least one internal electrode layer may be about 0.1 μm to about 2 μm.

An average thickness of the one dielectric layer may be about 0.2 μm to about 10 μm.

Another embodiment provides a method of manufacturing a multilayer ceramic capacitor which includes mixing nickel (Ni) and a germanium (Ge)-based raw material to prepare a conductive paste; manufacturing a dielectric green sheet from a dielectric slurry and applying the conductive paste on a surface of the dielectric green sheet to form a conductive paste layer; stacking a plurality of the dielectric green sheets having the conductive paste layer formed thereon to manufacture a dielectric green sheet stack; firing the dielectric green sheet stack to manufacture a capacitor body including a dielectric layer and an internal electrode layer; and forming an external electrode on an outer surface of the capacitor body, wherein the internal electrode layer includes an internal region and an interface region that is disposed on at least one surface of the internal region in a stacking direction, the interface region includes an interface with the dielectric layer, the internal region and the interface region include germanium (Ge), and an average content of germanium (Ge) in the interface region is higher than an average content of germanium (Ge) in the internal region.

The germanium (Ge)-based raw material may include at least one selected from germanium (Ge), germanium oxide (GeO₂), and a Ni—Ge alloy.

The germanium (Ge)-based raw material may be mixed in an amount of about 0.3 parts by mole to about 10 parts by mole based on 100 parts by mole of nickel (Ni).

The firing may be performed under an oxygen partial pressure condition of about 10⁻¹² atm to about 10⁻⁸ atm.

In another embodiment, a method of manufacturing a multilayer ceramic capacitor includes mixing a barium titanate-based compound and a germanium (Ge)-based raw material to prepare a dielectric slurry; manufacturing a dielectric green sheet from the dielectric slurry, and printing a conductive paste on a surface of the dielectric green sheet to form a conductive paste layer; stacking a plurality of the dielectric green sheets having the conductive paste layer formed thereon to manufacture a dielectric green sheet stack; firing the dielectric green sheet stack to manufacture a capacitor body including a dielectric layer and an internal electrode layer; and forming an external electrode on an outer surface of the capacitor body, wherein the internal electrode layer includes an internal region and an interface region that is disposed on at least one surface of the internal region in a stacking direction, the interface region includes an interface with the dielectric layer, the internal region and the interface region include germanium (Ge), and an average content of germanium (Ge) in the interface region is higher than an average content of germanium (Ge) in the internal region.

An embodiment provides a multilayer ceramic capacitor including a capacitor body including a plurality of dielectric layers and a plurality of internal electrode layers stacked with one dielectric layer among the plurality of dielectric layers interposed between adjacent internal electrode layers among the plurality of internal electrode layers; and an external electrode disposed on an outer surface of the capacitor body, wherein at least one internal electrode layer among the plurality of internal electrode layers includes an internal region and an interface region that is disposed on at least one surface of the internal region in a stacking direction, the interface region includes an interface with an dielectric layer among the plurality of dielectric layers, the internal region and the interface region include both germanium (Ge) and nickel (Ni), and an average content of germanium (Ge) in the interface region is 0.4 parts by mole to 12 parts by mole based on 100 parts by mole of nickel (Ni) in the interface region.

The average content of germanium (Ge) in the interface region may be different from an average content of germanium (Ge) in the internal region.

The interface region may be a region having a depth of 2 nm from the interface with the adjacent dielectric layer into an interior of the at least one internal electrode layer.

The average content of germanium (Ge) in the interface region may be higher than an average content of germanium (Ge) in the internal region.

Another embodiment provides a method of manufacturing the multilayer ceramic capacitor disclosed herein. The method includes mixing nickel (Ni) and germanium oxide (GeO₂) to prepare a conductive paste; manufacturing a dielectric green sheet from a dielectric slurry and applying the conductive paste on a surface of the dielectric green sheet to form a conductive paste layer; stacking a plurality of the dielectric green sheets having the conductive paste layer formed thereon to manufacture a dielectric green sheet stack; firing the dielectric green sheet stack to manufacture the capacitor body; and forming the external electrode on the outer surface of the capacitor body.

The firing may be performed at 1300° C. or lower and at a hydrogen concentration of 1.0% H₂ or less.

The firing may be performed under an oxygen partial pressure condition of 10⁻¹² atm to 10⁻⁸ atm.

Germanium oxide (GeO₂) may be mixed in an amount of 0.3 parts by mole to 10 parts by mole based on 100 parts by mole of nickel (Ni).

An embodiment provides a multilayer ceramic capacitor including a capacitor body including a plurality of dielectric layers and a plurality of internal electrode layers stacked with one dielectric layer among the plurality of dielectric layers interposed between adjacent internal electrode layers among the plurality of internal electrode layers; and an external electrode disposed on an outer surface of the capacitor body, wherein at least one internal electrode layer among the plurality of internal electrode layers includes an internal region and an interface region that is disposed on at least one surface of the internal region in a stacking direction, the interface region includes an interface with an dielectric layer among the plurality of dielectric layers, the internal region and the interface region include germanium (Ge), and an average content of germanium (Ge) in the interface region is different from an average content of germanium (Ge) in the internal region.

The internal region and the interface region may further include nickel (Ni), the average content of germanium (Ge) in the interface region may be 0.4 parts by mole to 12 parts by mole based on 100 parts by mole of nickel (Ni) in the interface region, and the average content of germanium (Ge) in the internal region may be 0.2 parts by mole to 10 parts by mole based on 100 parts by mole of nickel (Ni) in the internal region.

A ratio of the average content of germanium (Ge) in the interface region to the average content of germanium (Ge) in the internal region may be greater than 1 and less than or equal to 5.

The interface region may be a region having a depth of 2 nm from the interface with the adjacent dielectric layer into an interior of the at least one internal electrode layer.

A multilayer ceramic capacitor according to an embodiment may have improved reliability due to its high interfacial resistance.

### BRIEF DESCRIPTION OF THE DRAWINGS

FIG. 1 is a perspective view showing a multilayer ceramic capacitor according to an embodiment.

FIG. 2 is a cross-sectional view of a multilayer ceramic capacitor taken along line I-I′ of FIG. 1.

FIG. 3 is a cross-sectional view of a multilayer ceramic capacitor taken along line II-II′ of FIG. 1.

FIG. 4 is an exploded perspective view illustrating the stacked structure in the capacitor body of FIG. 1.

FIG. 5 shows the Ellingham diagram of nickel (Ni) and germanium (Ge).

FIGS. 6A to 6C are transmission electron microscope-energy dispersive spectroscopy (TEM-EDS) analysis images of the internal electrode layer according to Example 5.

FIGS. 7A to 7D are transmission electron microscope-energy dispersive spectroscopy (TEM-EDS) mapping analysis images for the internal electrode layer according to Example 5.

FIGS. 8A and 8B are energy dispersive spectroscopy (EDS) line graphs for the straight section of FIG. 7A.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

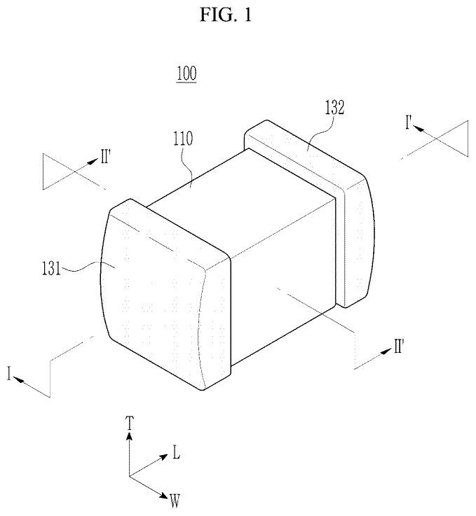

Hereinafter, a multilayer ceramic capacitor according to an embodiment will be described with reference to FIGS. 1 to 4.

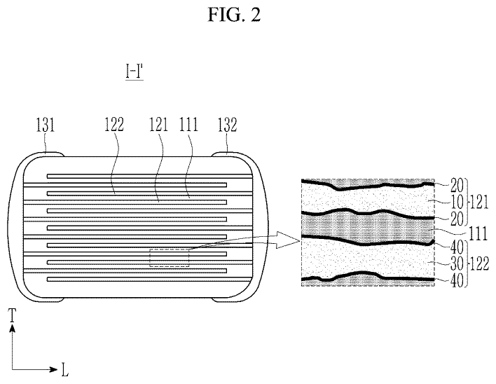

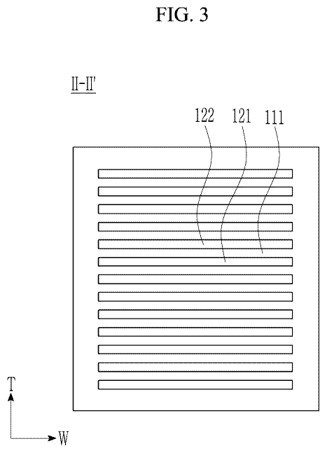

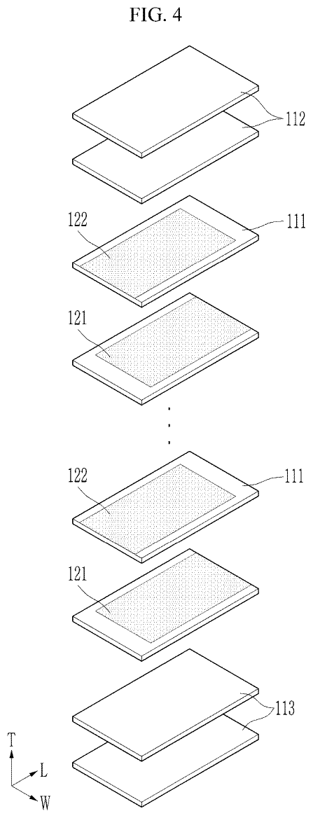

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are disposed. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed on an outer surface of the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundary between each adjacent dielectric layer 111 of the capacitor body 110 may be integrated to a degree that it is difficult to confirm without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be disposed on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be disposed on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin area serve to prevent damage to the first internal electrode layer 121 and the second internal electrode layer 122 due to physical or chemical stress.

Hereinafter, each of the internal electrode layer, dielectric layer, and external electrode is described in detail.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

Referring to FIG. 2, the internal electrode layers 121 and 122 according to an embodiment may include internal regions 10 and 30, and interface regions 20 and 40 disposed on at least one surface of the internal regions 10 and 30 in a stacking direction and including an interface with the dielectric layer 111. In other words, the first internal electrode layer 121 may include the first internal region 10 and the first interface region 20 disposed on at least one surface of the first internal region 10 in the stacking direction and including an interface with the dielectric layer 111. In addition, the second internal electrode layer 122 may include the second internal region 30 and the second interface region 40 disposed on at least one surface of the second internal region 30 in the stacking direction and including an interface with the dielectric layer 111.

The internal regions 10 and 30 and the interface regions 20 and 40 of the internal electrode layers 121 and 122 may include germanium (Ge). Specifically, the interface regions 20 and 40 may have a higher average germanium (Ge) content than the internal regions 10 and 30.

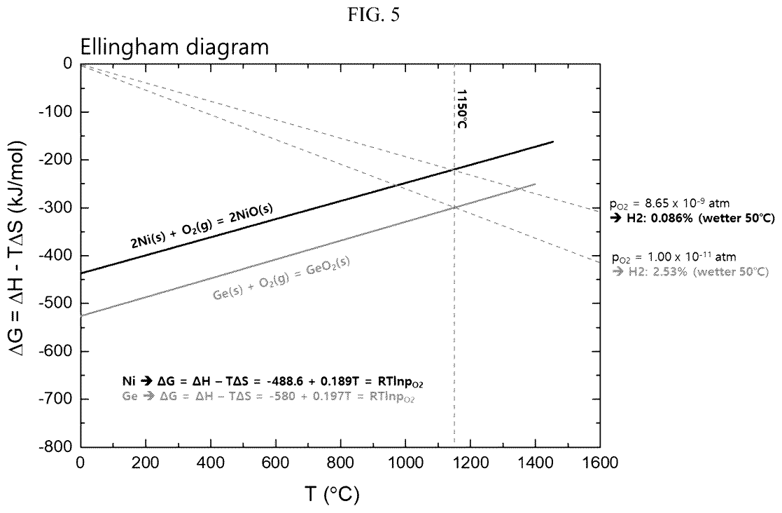

FIG. 5 shows the Ellingham diagram of nickel (Ni) and germanium (Ge).

In manufacturing the multilayer ceramic capacitor, a firing process may cause oxidation of nickel (Ni), a material of the internal electrode layer, and thus form nickel oxide. The formation of the nickel oxide causes a decrease in high temperature reliability of the multilayer ceramic capacitor.

As shown in FIG. 5, germanium (Ge) is an element having a stronger oxidation tendency than nickel (Ni). If this germanium (Ge) is applied to the internal electrode layer of the multilayer ceramic capacitor, the germanium (Ge) may act as a catalyst of promoting reduction of the Ni oxide and thus make Ge and GeO₂ coexist during the firing as well as suppress the oxidation of nickel. GeO₂ may be partially trapped on the interface between dielectric layer and internal electrode layer in a process of being squeezed out to the dielectric layer but partially remain in a reduced Ge state and exist in the internal electrode layer. Herein, GeO₂ disposed on the interface between dielectric layer and internal electrode layer may form a thin layer. The insulation layer of GeO₂ with bandgap energy of 6.6 eV, which is higher than 3.4 eV of BaTiO₃, has an effect of improving interfacial resistance, which may hinder interfacial electron movement between dielectric layer and internal electrode layer, thereby improving high temperature reliability of the multilayer ceramic capacitor.

In other words, according to an embodiment, if the germanium (Ge) may not only exist in the internal electrode layers 121 and 122 but also in a higher content in the interface regions 20 and 40 than the internal regions 10 and 30, interfacial resistance between dielectric layer 111 and internal electrode layers 121 and 122 may be increased, securing excellent reliability of the multilayer ceramic capacitor. In other words, if the interface regions have a lower average germanium (Ge) content than the internal regions of the internal electrode layer, an insulation layer of GeO₂ capable of increasing the interfacial resistance may not be formed, deteriorating reliability.

The average germanium (Ge) content may be parts by mole of Ge based on 100 parts by mole of nickel (Ni) in each region.

The interface regions 20 and 40 are each a region having a depth of 2 nm from the interface between the internal electrode layers 121 and 122 and the dielectric layer 111 toward the inside of the internal electrode layers 121 and 122.

Specifically, when a straight-line section from one point of the dielectric layer 111 to one point of the internal electrode layers 121 and 122 adjacent to the dielectric layer 111 is subjected to transmission electron microscope-energy dispersive spectroscopy (TEM-EDS) line analysis, the interface regions 20 and 40 of the internal electrode layers 121 and 122 may have a maximum mol % of germanium (Ge).

More specifically, when the straight-line section from one point of the dielectric layer 111 to one point of the internal electrode layers 121 and 122 adjacent to the dielectric layer 111 is subjected to transmission electron microscope-energy dispersive spectroscopy (TEM-EDS) line analysis, the interface of the internal electrode layers 121 and 122 and the dielectric layer 111 is defined as a point of about ⅓ of the maximum mol % of nickel (Ni), and the interface regions 20 and 40 are defined as a region from about ⅓ point of the maximum mol % of nickel (Ni) to a distance of 2 nm toward the inside of the internal electrode layer.

In some embodiments of the specification, the thickness of the interface regions 20 and 40 may be 2 nm.

The transmission electron microscope-energy dispersive spectroscopy (TEM-EDS) line analysis may be performed in the following method. After placing the multilayer ceramic capacitor 100 in an epoxy mixing solution and curing it, the W- and T-axis direction surface (WT surface) of the capacitor body 110 is polished to ½ of a depth in the L-axis direction. After the polishing, the polished surface is processed through ion milling and then fixed and maintained in a vacuum atmosphere chamber to obtain a cross-sectional sample for examining an active region where the dielectric layer 111 and the internal electrode layers 121 and 122 overlap each other. Subsequently, the active region of the cross-sectional sample is measured by taking an image of with a transmission electron microscope (TEM) so that at least one dielectric layer and at least one internal electrode layer may be visible therein. For example, when the active region of the cross-sectional sample is divided into three regions such as upper, central, and lower regions in the stacking direction, each region is measured with TEM, so that at least one dielectric layer and at least one internal electrode layer may be visible in each region. For example, TEM is measured at an acceleration voltage of 200 kV by using Focused Ion Beam (Xe-FIB) in a region of about 80 nm×80 nm where at least one dielectric layer and at least one internal electrode layer are visible in each upper, central, and lower region of the active region. Subsequently, in each of the measured TEM images of the cross-sectional sample, the straight-line section from one point of any dielectric layer to one point of the internal electrode layer adjacent to the dielectric layer is subjected to energy dispersive spectroscopy (EDS) line analysis. Through the EDS line analysis, the internal regions 10 and 30 may not only be distinguished from the interface regions 20 and 40, but also germanium (Ge) contents in these two regions may be compared. Other methods and/or tools appreciated by one of ordinary skill in the art, even if not described in the present disclosure, may also be used.

In addition, in each region, an average germanium (Ge) content may be obtained as follows. In each TEM image of the upper, central, and lower regions in the active region, at least one internal electrode layers 121 and 122 may be randomly selected per each region to respectively designate a plurality of points positioned in the interface regions 20 and 40 and a plurality of points positioned in the internal regions 10 and 30 per the internal electrode layers 121 and 122 of each region, and measure Ge contents through EDS, which are used to calculate an average value (X) of the Ge contents in the interface regions 20 and 40 and an average value (Y) of the Ge contents in the internal regions 10 and 30. For example, after selecting one internal electrode layer per the upper, central, and lower regions in the active region, any 3 points in the interface region and any 12 points in the internal region per each internal electrode layer are designated to measure Ge contents at each corresponding point through EDS, which are used to calculate each average value in the interface region and the internal region. In other words, the average Ge content (X) at a total of 9 points of the interface region (three points within the interface region ×3 internal electrode layers) and the average Ge content (Y) at a total of 36 points of the internal region (12 points within the internal region ×3 internal electrode layers) are calculated. The measured Ge average contents are based on 100 parts by mole of Ni in the corresponding region. Other methods and/or tools appreciated by one of ordinary skill in the art, even if not described in the present disclosure, may also be used.

Specifically, an average molar ratio of the germanium (Ge) in interface regions 20 and 40 to the internal regions 10 and 30, that is, X/Y, may be greater than about 1 and less than or equal to about 5, for example, about 1.2 to about 4.8 or about 1.4 to about 4.6. If the average molar ratio of the germanium (Ge) in interface regions to that in the internal regions is within the range, interfacial resistance between dielectric layer and internal electrode layer may be increased, improving reliability of the multilayer ceramic capacitor. The average Ge molar ratio may be obtained as a ratio of the average Ge content (X) in the internal region and the average Ge content (Y) in the interface region measured in the above method.

The interface regions 20 and 40 may further include germanium oxide (GeO₂). Herein, the interface region has a function as an insulation layer and thus may further increase the interfacial resistance between dielectric layer and internal electrode layer.

The germanium (Ge) in the internal electrode layers 121 and 122 may be derived from the germanium (Ge)-based raw material which is mixed with a nickel (Ni) main component during the formation of the internal electrode layer, or derived and diffused from the germanium (Ge)-based raw material, which is mixed with a barium titanate-based compound as a main component for forming the dielectric layer.

The internal regions 10 and 30 and the interface regions 20 and 40 of the internal electrode layers 121 and 122 may further include nickel (Ni).

In the transmission electron microscope-energy dispersive spectroscopy (TEM-EDS) line analysis of the straight-line section from one point of the dielectric layer 111 to one point of the internal electrode layers 121 and 122 adjacent to the dielectric layer 111, the internal regions 10 and 30 may have a maximum mol % of nickel (Ni).

Specifically, the average germanium (Ge) content in the interface regions 20 and 40, that is, X may be about 0.4 parts by mole to about 12 parts by mole, for example, about 0.45 parts by mole to about 11 parts by mole or about 0.5 parts by mole to about 10 parts by mole based on 100 parts by mole of nickel (Ni). If the average germanium (Ge) content in the interface region of the internal electrode layer is within the ranges, a melting point of a Ni—Ge alloy formed in the internal electrode layer may be maintained at an appropriate level, minimizing balling phenomenon of an electrode and thereby, improving reliability.

In addition, the average germanium (Ge) content in the internal regions 10 and 30, that is, Y may be about 0.2 parts by mole to about 10 parts by mole based on 100 parts by mole of nickel (Ni) in the internal regions 10 and 30, for example, about 0.3 parts by mole to about 9 parts by mole or about 0.5 parts by mole to about 8 parts by mole. If the average germanium (Ge) content is within the ranges in the internal region of the internal electrode layer, interfacial resistance between dielectric layer and internal electrode layer may be increased, thereby improving reliability of the multilayer ceramic capacitor.

The interface regions 20 and 40 may further include at least one selected from titanium (Ti) and barium (Ba) in addition to the germanium (Ge) and the nickel (Ni). The titanium (Ti) and the barium (Ba) may be derived and diffused from the barium titanate-based compound used as a main component to form the dielectric layer or from the barium titanate powder added as co-material, if necessary, to form the internal electrode layer.

The interface regions 20 and 40 may have a thickness of about 0.05% to about 3% of a total thickness of the internal electrode layers 121 and 122 having the internal regions 10 and 30 and the interface regions 20 and 40 in the stacking direction, for example, about 0.07% to about 2.8% or about 0.1% to about 2.5% of a thickness of the total thickness of the internal electrode layer. If the interface regions have a thickness within the ranges, the interfacial resistance between dielectric layer and internal electrode layer may be increased, thereby improving reliability of the multilayer ceramic capacitor.

The total thickness of the internal electrode layers 121 and 122 may mean an average thickness of the internal electrode layers 121 and 122.

The average thickness of the internal electrode layers 121 and 122 may be about 0.1 μm to about 2 μm. If the average thickness of the internal electrode layers is within the range, the multilayer ceramic capacitor may have excellent reliability.

The thickness of the interface regions 20 and 40 and the thickness of the internal electrode layers 121 and 122 may be measured in the following method. After the multilayer ceramic capacitor 100 is placed into the epoxy mixing solution and then cured, the W-axis and the T-axis directional surface (WT surface) of the capacitor body 110 is polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 overlap may be observed. Then, the active region of the cross-sectional sample may be measured using a scanning electron microscope (SEM) so that at least one layer, for example, one to five layers of the dielectric layer and the internal electrode layer are visible. For example, SEM can be measured under conditions of 10 kV in an area of about 400 nm×400 nm, where at least one dielectric layer and one internal electrode layer are visible in the active region, using a Verios G4 product from Thermofisher Scientific.

In the SEM image of the cross-sectional sample, after designating a central point in a length direction (L-axis direction) or a width direction (W-axis direction) of the internal electrode layers 121 and 122 as a reference point, ten points are marked to be spaced apart at a predetermined interval from the reference point to calculate an arithmetic mean of thicknesses of the internal electrode layers 121 and 122. The space of the ten points may be adjusted according to a scale of the scanning electron microscope (SEM) image, for example, 1 μm to 100 μm, 1 μm to 50 μm, or 1 μm to 10 μm. Herein, all the ten points should be positioned within the internal electrode layers 121 and 122, but if not within internal electrode layers 121 and 122, the reference point may be re-positioned, or the space therebetween may be adjusted. In some embodiments of the application, the thickness of the interface regions 20 and 40 may be obtained from TEM-EDS line analysis described herein. Other methods and/or tools appreciated by one of ordinary skill in the art, even if not described in the present disclosure, may also be used.

### Dielectric Layer

The dielectric layer 111 may include a barium titanate-based compound including barium (Ba) and titanium (Ti) as a main component.

The barium titanate-based compound is a dielectric base material, has a high dielectric constant, and contributes to forming the dielectric constant of the multilayer ceramic capacitor 100.

For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃, and (Ba, Sr)(Ti, Sn)O₃.

The dielectric layer 111 may include germanium (Ge) in addition to barium (Ba) and titanium (Ti).

The germanium (Ge) in the dielectric layer 111 may be derived and diffused from a germanium (Ge)-based raw material mixed with the nickel main component during the formation of the internal electrode layer, or may be derived from a germanium (Ge)-based raw material mixed with the barium titanate-based compound, which is the main component during the formation of the dielectric layer.

The dielectric layer 111 may further include a subcomponent. The subcomponent may include, for example, at least one selected from manganese (Mn), chromium (Cr), silicon (Si), aluminum (Al), magnesium (Mg), tin (Sn), antimony (Sb), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 0.2 μm to about 10 μm, for example, about 0.2 μm to about 8.0 μm. When the average thickness of the dielectric layer 111 is within the above range, the reliability of the multilayer ceramic capacitor may be improved.

This may be obtained as an arithmetic mean value obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be disposed within the dielectric layer 111, and if all 10 points are not disposed within the dielectric layer 111, the position of the reference point may be changed, or the interval between the 10 points may be adjusted. Other methods and/or tools appreciated by one of ordinary skill in the art, even if not described in the present disclosure, may also be used.

The capacitor body 110 may be formed by firing a stacked structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include at least one selected from copper (Cu), nickel (Ni), silver (Ag), palladium (Pd), gold (Au), platinum (Pt), tin (Sn), tungsten (W), titanium (Ti), lead (Pb), an alloy thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from zinc (Zn), titanium (Ti), copper (Cu), vanadium (V), manganese (Mn), iron (Fe) and nickel (Ni), the alkali metal may be selected from lithium (Li), sodium (Na) and potassium (K), and the alkaline-earth metal may be at least one selected from magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the external electrodes 131 and 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed on an outer surface of the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) plating layer or a tin (Sn) plating layer, may be a form in which the nickel (Ni) plating layer and the tin (Sn) plating layer are sequentially stacked, or may be a form in which the tin (Sn) plating layer, the nickel (Ni) plating layer, and the tin (Sn) plating layer are sequentially stacked. In addition, the plating layer may include a plurality of nickel (Ni) plating layers and/or a plurality of tin (Sn) plating layers.

The plating layer may improve mountability to the substrate, structural reliability, durability to the outer portion, heat resistance, and equivalent series resistance (ESR) of the multilayer ceramic capacitor 100.

### Method of Manufacturing Multilayer Ceramic Capacitor

Hereinafter, a method of manufacturing the aforementioned multilayer ceramic capacitor 100 according to an embodiment will be described.

The multilayer ceramic capacitor 100 may be manufactured by mixing nickel (Ni) and germanium (Ge)-based raw material to prepare a conductive paste; manufacturing a dielectric green sheet from a dielectric slurry and printing the conductive paste on a surface of the dielectric green sheet to form a conductive paste layer; stacking a plurality of the dielectric green sheets having the conductive paste layer formed thereon to manufacture a dielectric green sheet stack; firing the dielectric green sheet stack to manufacture a capacitor body including a dielectric layer and an internal electrode layer; and forming an external electrode on an outer surface of the capacitor body.

The germanium (Ge)-based raw material may include at least one selected from germanium (Ge), germanium oxide (GeO₂), and a Ni—Ge alloy.

The germanium (Ge)-based raw material may be mixed in an amount of about 0.3 parts by mole to about 10 parts by mole, for example, about 0.4 parts by mole to about 9 parts by mole, or about 0.5 parts by mole to about 8 parts by mole based on 100 parts by mole of nickel (Ni). When the germanium (Ge)-based raw material is mixed within the above content range, the germanium (Ge) is distributed in a higher content at the interface with the dielectric layer than inside the internal electrode layer, and accordingly, a multilayer ceramic capacitor having high interfacial resistance between the dielectric layer and the internal electrode layer and excellent reliability may be obtained.

In addition to nickel (Ni), the conductive paste may be prepared by further mixing one or more conductive metals selected from copper (Cu), silver (Ag), palladium (Pd), gold (Au), and an alloy thereof, such as an Ag—Pd alloy.

Additionally, the conductive paste may be prepared by additionally mixing a conductive powder, a binder, and a solvent. Additionally, barium titanate-based powder may be mixed in as a co-material if necessary. The co-material may act to inhibit the sintering of the conductive powder during the firing process.

The dielectric slurry may be prepared by mixing a barium titanate-based compound as a main component powder and optionally a subcomponent powder. The subcomponent powder may be an oxide or salt compound, or may be used in the form of a sol dispersed in an organic solvent.

In addition, the dielectric slurry may be prepared by additionally mixing additives such as a dispersant, a binder, a plasticizer, a lubricant, an antistatic agent, and a solvent.

The dispersant may include, for example, at least one selected from a phosphoric acid ester-based dispersant and a polycarboxylic acid-based dispersant. The dispersant may be mixed in an amount of about 0.1 part by weight to about 5 parts by weight, for example, about 0.3 parts by weight to about 3 parts by weight based on 100 parts by weight of the barium titanate-based compound powder. When the dispersant is mixed within the above content range, the dispersibility of the dielectric slurry is excellent, and the amount of impurities included in the manufactured dielectric layer can be reduced.

The binder may be, for example, an acrylic resin, a polyvinylbutyral resin, a polyvinylacetal resin, an ethyl cellulose resin, or the like. The binder may be added in an amount of about 0.1 part by weight to about 50 parts by weight, for example, about 3 parts by weight to about 30 parts by weight, based on 100 parts by weight of the barium titanate-based compound powder. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl)phthalate, and di(2-ethylbutyl)phthalate; an adipic acid-based compound such as dihexyl adipate and di(2-ethylhexyl)adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound powder. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering dissolubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound powder. When the solvent is mixed within the above content range, the dielectric slurry components may be sufficiently mixed, and subsequent removal of the solvent is easy.

The aforementioned dielectric slurry may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing. As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

The conductive paste layer is formed by applying a conductive paste to the surface of the dielectric green sheet in a predetermined pattern using various printing methods such as screen printing or transfer methods.

According to an embodiment, a germanium (Ge)-based raw material may be used to prepare a dielectric slurry for forming a dielectric layer instead of a conductive paste for forming an internal electrode layer. In other words, the multilayer ceramic capacitor 100 may be manufactured by mixing a barium titanate-based compound and the germanium (Ge)-based raw material to prepare the dielectric slurry, manufacturing the dielectric slurry into a dielectric green sheet, and printing the conductive paste including nickel (Ni) on the surface of the dielectric green sheet to form a conductive paste layer.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is disposed on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode. For example, the firing may be performed at a temperature of about 1100° C. to about 1400° C., and may be performed at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen. Additionally, the firing may be performed under oxygen partial pressure conditions of about 10⁻¹² atm to about 10⁻⁸ atm. When the firing is performed under the oxygen partial pressure conditions of the above range, a multilayer ceramic capacitor having high interfacial resistance between the dielectric layer and the internal electrode layer and excellent reliability may be obtained. The oxygen partial pressure may be measured by an oxygen gas sensor. Other methods and/or tools appreciated by one of ordinary skill in the art, even if not described in the present disclosure, may also be used.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the on the outer surface of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 10 and Comparative Examples 1 and 2

Ni and GeO₂ were mixed to prepare a conductive paste. Herein, GeO₂ was mixed in such amount that Ge was included in an amount of parts by mole shown in Table 1 based on 100 parts by mole of Ni.

Subsequently, barium titanate (BaTiO₃) powder was used to prepare a dielectric slurry. Here, the dielectric slurry included ethanol/toluene, a dispersant, and a binder, and the slurry was mechanically milled by using a zirconia (ZrO₂) ball as a dispersion medium.

The dielectric slurry was discharged from a head discharge type on-roll forming coater to manufacture a dielectric green sheet. On the surface of the dielectric green sheet, the prepared conductive paste was printed to form a conductive paste layer.

The dielectric green sheets on which the conductive paste layer was formed were stacked and compressed to form a dielectric green sheet stack.

Each dielectric green sheet stack was calcined at 400° C. or lower under a nitrogen atmosphere and fired at 1300° C. or lower at a hydrogen concentration of 1.0% H₂ or less within an oxygen partial pressure range of 10⁻¹² atm to 10⁻⁸ atm.

Subsequently, the dielectric green sheet stack was used to manufacture a multilayer ceramic capacitor through processes such as forming an external electrode, plating, or the like.

TABLE 1

| | Ge (parts by mole) |
|---|---|
| Example 1 | 0.3 |
| Example 2 | 0.4 |
| Example 3 | 1 |
| Example 4 | 1.1 |
| Example 5 | 1.3 |
| Example 6 | 1.25 |
| Example 7 | 1.4 |
| Example 8 | 3.5 |
| Example 9 | 5.5 |
| Example 10 | 6.5 |
| Comparative Example 1 | 0 |
| Comparative Example 2 | 0.2 |

### Evaluation 1: TEM-EDS Analysis

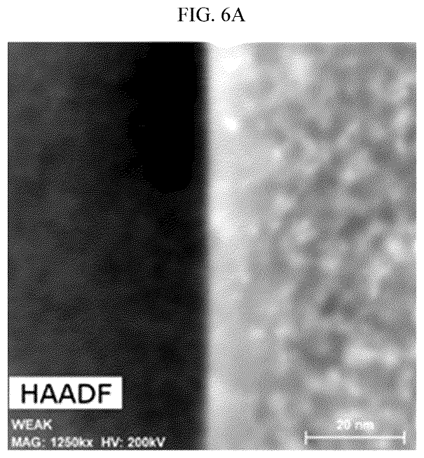

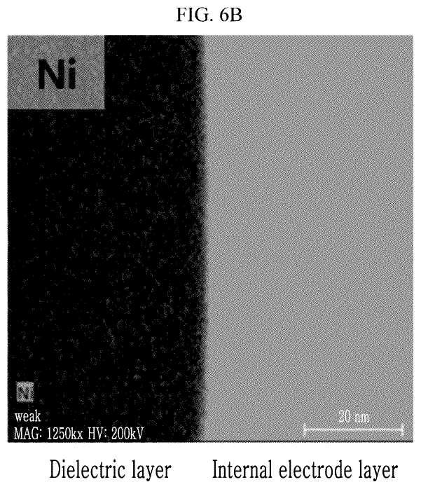

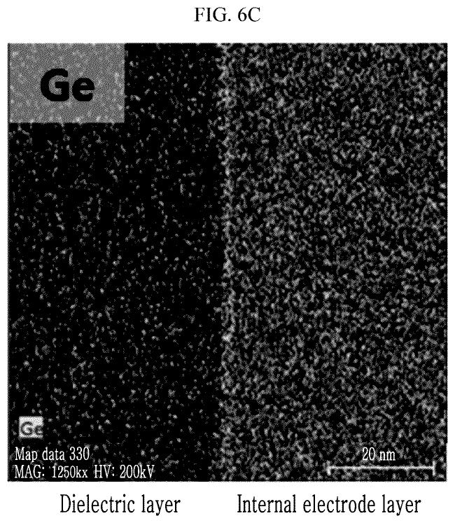

Each of the manufactured multilayer ceramic capacitors was subjected to transmission electron microscope-energy dispersive spectroscopy (TEM-EDS) analysis, and the results are shown in FIGS. 6A to 8B and Table 1.

Specifically, the multilayer ceramic capacitor of Example 5 was placed in an epoxy mixing solution and cured, and after polishing the W-axis and T-axis surface (WT plane) of the capacitor body to a ½ depth in a L-axis direction, the polished surface was ion-milled and then fixed and maintained in a vacuum atmosphere chamber to examine an active region where a dielectric layer and an internal electrode layer overlapped each other, obtaining a cross-sectional sample. Subsequently, the active region of the cross-sectional sample was divided into three portions such as upper, central, and lower regions in the stacking direction and then subjected to a transmission electron microscope (TEM) analysis so that at least one dielectric layer and one internal electrode layer in each region were observed. The TEM measurement was performed by using Focused Ion Beam (Xe-FIB) at an acceleration voltage of 200 kV in a region of about 80 nm×80 nm showing at least one dielectric layer and at least one internal electrode layer in each of the upper, central, and lower regions of the active region. Subsequently, each TEM image of the cross-sectional sample was subjected to energy dispersive spectroscopy (EDS) analysis.

FIGS. 6A to 6C are transmission electron microscope-energy dispersive spectroscopy (TEM-EDS) analysis images of the internal electrode layer according to Example 5.

Referring to FIGS. 6A to 6C, Example 5 exhibited a larger average content of Ge on the interface of the internal electrode layer with the dielectric layer than inside the internal electrode layer. In other words, an interface region including the interface with the dielectric layer, that is, a region from the interface between dielectric layer and internal electrode layer to a depth of about 2 nm toward the internal electrode layer exhibited a larger Ge average content than the other region, an internal region.

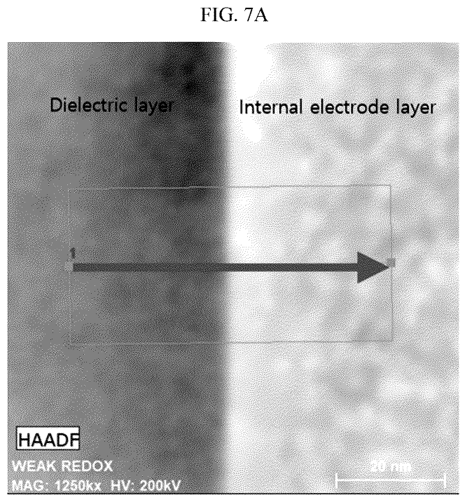

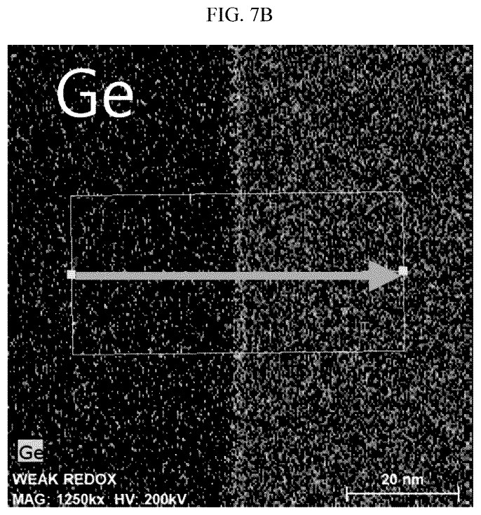

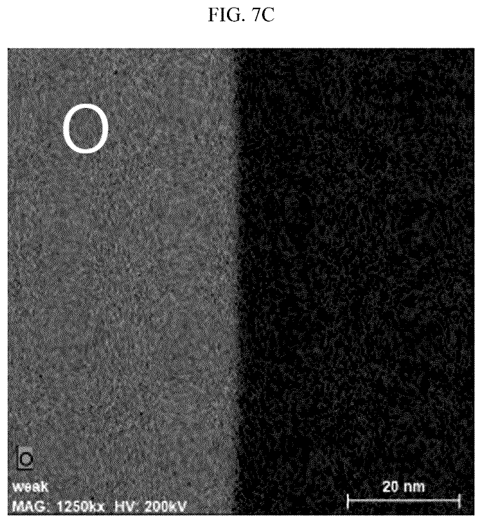

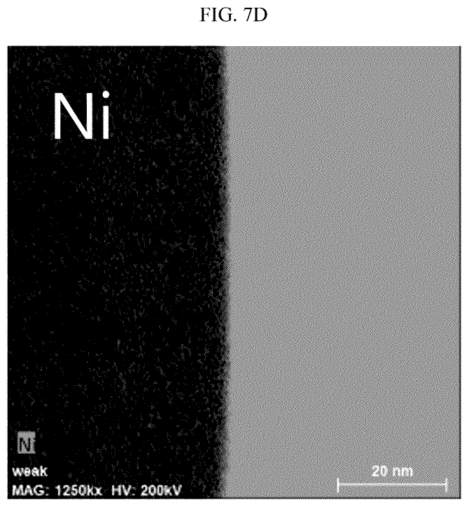

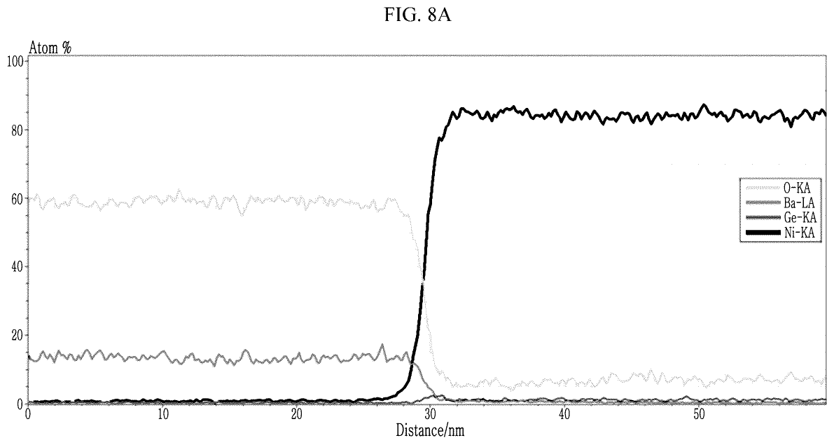

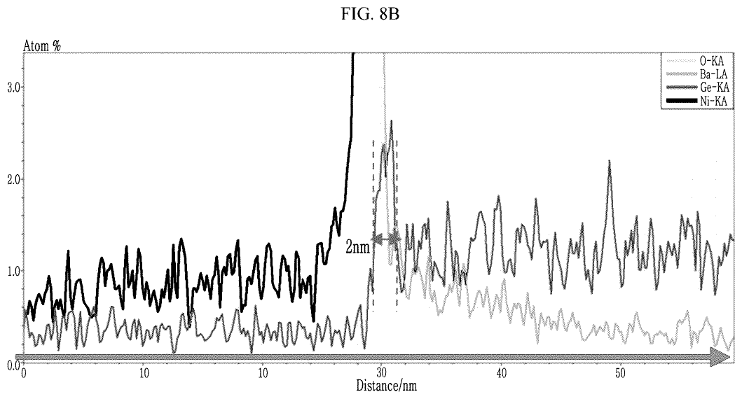

In addition, the TEM image of the cross-sectional sample was subjected to energy dispersive spectroscopy (EDS) line analysis on a straight-line section from one point in any internal electrode layer to one point in the dielectric layer adjacent to the internal electrode layer, and the results are shown in FIGS. 7A to 8B.

FIGS. 7A to 7D are transmission electron microscope-energy dispersive spectroscopy (TEM-EDS) mapping analysis images for the internal electrode layer according to Example 5, and FIGS. 8A and 8B are energy dispersive spectroscopy (EDS) line graphs for the straight section of FIG. 7A.

Referring to FIGS. 7A to 8B, the internal electrode layer of Example 5 had a maximum mol % of Ge in the interface region. Herein, the interface between dielectric layer and internal electrode layer was at a point of about ⅓ of a maximum mol % of Ni, and the interface region was a region extending from the point of about ⅓ of the maximum mol % of Ni to a distance of 2 nm toward the inside of the internal electrode layer. In addition, in the internal electrode layer of Example 1, the interface region had a larger average Ge content than the internal region, which was the remaining region.

In addition, in each TEM image of the upper, central, and lower regions of the active region, after selecting one internal electrode layer per each region, any three points within the interface region and any three points within the internal region per each internal electrode layer were designated and subjected to EDS to measure Ge contents at the corresponding points, which were used to calculate each average value in the interface region and the internal region. In other words, the average value (X) of the Ge contents at a total of 9 points (three points within the interface region x three internal electrode layers) in the interface region and the average value (Y) of the Ge contents at a total of 36 points (twelve points within the internal region x three internal electrode layers) were calculated. The results are shown in Table 2. Herein, the measured average Ge contents were expressed based on 100 parts by mole of Ni in the corresponding region.

Referring to Table 2, the internal electrode layers of Examples 1 to 10 exhibited a larger average Ge content in the interface region than in the internal region.

### Evaluation 2: Reliability

The mean time to failure (MTTF) of the multilayer ceramic capacitors according to Examples 1 to 10 and Comparative Examples 1 and 2 were measured in the following method, and the results are shown in Table 1.

MTTF (mean time to failure) (hr) was measured under conditions of a voltage of 9.45 V, 125° C., and 48 hours.

In Table 2, MTTF was provided as each ratio based on the result of Example 1.

TABLE 2

| | X | Y | |
|---|---|---|---|
| | Ge average content | Ge average content | |
| | in the interface region | in internal region | |
| | (parts by mole) | (parts by mole) | MTTF |
| Example 1 | 0.43 | 0.21 | 1 |
| Example 2 | 0.51 | 0.33 | 1.15 |
| Example 3 | 1.23 | 0.91 | 1.5 |
| Example 4 | 2.2 | 0.98 | 1.65 |
| Example 5 | 2.84 | 1.19 | 1.66 |
| Example 6 | 2.95 | 1.14 | 1.69 |
| Example 7 | 3.04 | 1.2 | 1.64 |
| Example 8 | 5.74 | 3.17 | 1.41 |
| Example 9 | 7.15 | 4.75 | 1.29 |
| Example 10 | 11.67 | 5.89 | 1.11 |
| Comparative Example 1 | 0 | 0 | 0.60 |
| Comparative Example 2 | 0.18 | 0.18 | 0.79 |

Referring to Table 2, Examples 1 to 10 exhibited excellent reliability, compared with Comparative Examples 1 and 2. Accordingly, when the average Ge content of the interface region was larger than that of the internal region in the internal electrode layer according to an embodiment, high interfacial resistance was achieved, thereby securing excellent reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body comprising a plurality of dielectric layers and a plurality of internal electrode layers stacked with one dielectric layer among the plurality of dielectric layers interposed between adjacent internal electrode layers among the plurality of internal electrode layers; and
an external electrode disposed on an outer surface of the capacitor body,
wherein at least one internal electrode layer among the plurality of internal electrode layers comprises:
an internal region, and
an interface region that is disposed on at least one surface of the internal region in a stacking direction, the interface region comprising an interface with an adjacent dielectric layer among the plurality of dielectric layers,
the internal region and the interface region comprise germanium (Ge), and
an average content of germanium (Ge) in the interface region is higher than an average content of germanium (Ge) in the internal region.

2. The multilayer ceramic capacitor of claim 1, wherein
a ratio of the average content of germanium (Ge) in the interface region to the average content of germanium (Ge) in the internal region is greater than 1 and less than or equal to 5.

3. The multilayer ceramic capacitor of claim 1, wherein
the interface region is a region having a depth of 2 nm from the interface with the adjacent dielectric layer into an interior of the at least one internal electrode layer.

4. The multilayer ceramic capacitor of claim 1, wherein
in a transmission electron microscopy-energy dispersive spectroscopy (TEM-EDS) image, when analyzing a line in a straight section from one point of the at least one internal electrode layer to one point of the adjacent dielectric layer,
the interface region has a maximum mol % of germanium (Ge).

5. The multilayer ceramic capacitor of claim 1, wherein
the interface region further comprises germanium oxide (GeO₂).

6. The multilayer ceramic capacitor of claim 1, wherein
the internal region and the interface region further comprise nickel (Ni).

7. The multilayer ceramic capacitor of claim 6, wherein
in a transmission electron microscopy-energy dispersive spectroscopy (TEM-EDS) image, when analyzing a line in a straight section from one point of the adjacent dielectric layer to one point of the at least one internal electrode layer,
the internal region has a maximum mol % of nickel (Ni).

8. The multilayer ceramic capacitor of claim 6, wherein
in a transmission electron microscopy-energy dispersive spectroscopy (TEM-EDS) image, when analyzing a line in a straight section from one point of the adjacent dielectric layer to the at least one internal electrode layer,
the interface region is a region extending from a point having a concentration of nickel (Ni) that is ⅓ of a maximum mol % of nickel (Ni) to a distance of 2 nm into an interior of the at least one internal electrode layer.

9. The multilayer ceramic capacitor of claim 6, wherein
the average content of germanium (Ge) in the interface region is 0.4 parts by mole to 12 parts by mole based on 100 parts by mole of nickel (Ni) in the interface region.

10. The multilayer ceramic capacitor of claim 6, wherein
the interface region further comprises at least one selected from titanium (Ti) and barium (Ba).

11. The multilayer ceramic capacitor of claim 6, wherein
the average content of germanium (Ge) in the internal region is 0.2 parts by mole to 10 parts by mole based on 100 parts by mole of nickel (Ni) in the internal region.

12. The multilayer ceramic capacitor of claim 1, wherein
the interface region has a thickness of 0.05% to 3% of a total thickness of the at least one internal electrode layer.

13. The multilayer ceramic capacitor of claim 1, wherein
the plurality of dielectric layers comprise barium (Ba), titanium (Ti) and germanium (Ge).

14. The multilayer ceramic capacitor of claim 1, wherein
an average thickness of the at least one internal electrode layer is 0.1 μm to 2 μm.

15. The multilayer ceramic capacitor of claim 1, wherein
an average thickness of the one dielectric layer is 0.2 μm to 10 μm.

16. A method of manufacturing a multilayer ceramic capacitor, comprising
mixing nickel (Ni) and a germanium (Ge)-based raw material to prepare a conductive paste;
manufacturing a dielectric green sheet from a dielectric slurry and applying the conductive paste on a surface of the dielectric green sheet to form a conductive paste layer;
stacking a plurality of the dielectric green sheets having the conductive paste layer formed thereon to manufacture a dielectric green sheet stack;
firing the dielectric green sheet stack to manufacture a capacitor body comprising a dielectric layer and an internal electrode layer; and
forming an external electrode on an outer surface of the capacitor body,
wherein the internal electrode layer comprises:
an internal region, and
an interface region that is disposed on at least one surface of the internal region in a stacking direction, the interface region comprising an interface with the dielectric layer,
the internal region and the interface region comprise germanium (Ge), and an average content of germanium (Ge) in the interface region is higher than an average content of germanium (Ge) in the internal region.

17. The method of claim 16, wherein
the germanium (Ge)-based raw material comprises at least one selected from germanium (Ge), germanium oxide (GeO₂), and a Ni—Ge alloy.

18. The method of claim 16, wherein
the germanium (Ge)-based raw material is mixed in an amount of 0.3 parts by mole to 10 parts by mole based on 100 parts by mole of nickel (Ni).

19. The method of claim 16, wherein
the firing is performed under an oxygen partial pressure condition of 10⁻¹² atm to 10⁻⁸ atm.

20. A method of manufacturing a multilayer ceramic capacitor, comprising
mixing a barium titanate-based compound and a germanium (Ge)-based raw material to prepare a dielectric slurry;
manufacturing a dielectric green sheet from the dielectric slurry, and printing a conductive paste on a surface of the dielectric green sheet to form a conductive paste layer;
stacking a plurality of the dielectric green sheets having the conductive paste layer formed thereon to manufacture a dielectric green sheet stack;
firing the dielectric green sheet stack to manufacture a capacitor body comprising a dielectric layer and an internal electrode layer; and
forming an external electrode on an outer surface of the capacitor body,
wherein the internal electrode layer comprises:
an internal region, and
an interface region that is disposed on at least one surface of the internal region in a stacking direction, the interface region comprising an interface with the dielectric layer,
the internal region and the interface region comprise germanium (Ge), and an average content of germanium (Ge) in the interface region is higher than an average content of germanium (Ge) in the internal region.

21. The method of claim 20, wherein
the germanium (Ge)-based raw material comprises at least one selected from germanium (Ge), germanium oxide (GeO₂), and a Ni—Ge alloy.

22. The method of claim 20, wherein
the firing is performed under an oxygen partial pressure condition of 10⁻¹² atm to 10⁻⁸ atm.

23. A multilayer ceramic capacitor, comprising
a capacitor body comprising a plurality of dielectric layers and a plurality of internal electrode layers stacked with one dielectric layer among the plurality of dielectric layers interposed between adjacent internal electrode layers among the plurality of internal electrode layers; and
an external electrode disposed on an outer surface of the capacitor body,
wherein at least one internal electrode layer among the plurality of internal electrode layers comprises:
an internal region, and
an interface region that is disposed on at least one surface of the internal region in a stacking direction, the interface region comprising an interface with an adjacent dielectric layer among the plurality of dielectric layers,
the internal region and the interface region comprise both germanium (Ge) and nickel (Ni), and
an average content of germanium (Ge) in the interface region is 0.4 parts by mole to 12 parts by mole based on 100 parts by mole of nickel (Ni) in the interface region.

24. The multilayer ceramic capacitor of claim 23, wherein
the average content of germanium (Ge) in the interface region is different from an average content of germanium (Ge) in the internal region.

25. The multilayer ceramic capacitor of claim 23, wherein
the interface region is a region having a depth of 2 nm from the interface with the adjacent dielectric layer into an interior of the at least one internal electrode layer.

26. The multilayer ceramic capacitor of claim 25, wherein
the average content of germanium (Ge) in the interface region is higher than an average content of germanium (Ge) in the internal region.

27. A method of manufacturing the multilayer ceramic capacitor of claim 23, comprising
mixing nickel (Ni) and germanium oxide (GeO₂) to prepare a conductive paste;
manufacturing a dielectric green sheet from a dielectric slurry and applying the conductive paste on a surface of the dielectric green sheet to form a conductive paste layer;
stacking a plurality of the dielectric green sheets having the conductive paste layer formed thereon to manufacture a dielectric green sheet stack;
firing the dielectric green sheet stack to manufacture the capacitor body; and
forming the external electrode on the outer surface of the capacitor body.

28. The method of claim 27, wherein the firing is performed at 1300° C. or lower and at a hydrogen concentration of 1.0% H₂ or less.

29. The method of claim 28, wherein the firing is performed under an oxygen partial pressure condition of 10⁻¹² atm to 10⁻⁸ atm.

30. The method of claim 29, wherein germanium oxide (GeO₂) is mixed in an amount of 0.3 parts by mole to 10 parts by mole based on 100 parts by mole of nickel (Ni).

31. A multilayer ceramic capacitor, comprising
a capacitor body comprising a plurality of dielectric layers and a plurality of internal electrode layers stacked with one dielectric layer among the plurality of dielectric layers interposed between adjacent internal electrode layers among the plurality of internal electrode layers; and
an external electrode disposed on an outer surface of the capacitor body,
wherein at least one internal electrode layer among the plurality of internal electrode layers comprises:
an internal region, and
an interface region that is disposed on at least one surface of the internal region in a stacking direction, the interface region comprising an interface with an adjacent dielectric layer among the plurality of dielectric layers,
the internal region and the interface region comprise germanium (Ge), and
an average content of germanium (Ge) in the interface region is different from an average content of germanium (Ge) in the internal region.

32. The multilayer ceramic capacitor of claim 31, wherein
the internal region and the interface region further comprise nickel (Ni),
the average content of germanium (Ge) in the interface region is 0.4 parts by mole to 12 parts by mole based on 100 parts by mole of nickel (Ni) in the interface region, and
the average content of germanium (Ge) in the internal region is 0.2 parts by mole to 10 parts by mole based on 100 parts by mole of nickel (Ni) in the internal region.

33. The multilayer ceramic capacitor of claim 31, wherein
a ratio of the average content of germanium (Ge) in the interface region to the average content of germanium (Ge) in the internal region is greater than 1 and less than or equal to 5.

34. The multilayer ceramic capacitor of claim 31, wherein
the interface region is a region having a depth of 2 nm from the interface with the adjacent dielectric layer into an interior of the at least one internal electrode layer.
